(19) United States
(12) Patent Application Publication
(10) Pub. No.: US 2019/0166277 A1
(43) Pub. Date: May 30, 2019

(54) IMAGE PROCESSING APPARATUS, CONTROL METHOD FOR IMAGE PROCESSING APPARATUS, IMAGE PROCESSING SYSTEM, AND PROGRAM

(71) Applicant: KONICA MINOLTA, INC., Tokyo (JP)

(72) Inventor: Takashi Oikawa, Toyohashi-shi (JP)

(73) Assignee: KONICA MINOLTA, INC., Tokyo (JP)

(21) Appl. No.: 16/180,436

(22) Filed: Nov. 5, 2018

(30) Foreign Application Priority Data
Nov. 30, 2017 (JP) 2017-230642

(51) Int. Cl. H04N 1/00; H04N 1/327; H04N 1/32

(52) U.S. Cl. CPC H04N 1/00973; H04N 1/00244; H04N 2201/0094; H04N 1/32507; H04N 1/32771

(57) ABSTRACT

An image processing apparatus includes: a hardware processor that accepts, from a client, a request for an API relating to the image processing apparatus, determines a client type of the client, which is a transmission source device of the request, based on history information of an API request from each client, and determines response information for the request for the API, based on the client type of the client; and a transmitter that transmits the determined response information to the client.

The entire disclosure of Japanese patent Application No. 2017-230642, filed on Nov. 30, 2017, is incorporated herein by reference in its entirety.

### BACKGROUND

### Technological Field

The present invention relates to an image processing apparatus such as a multi-function peripheral (MFP) and technology related thereto.

### Description of the Related Art

In recent years, there has been technology for a service provided by a web server, in which an application programming interface (API) is provided to be used by a client that receives such a service. Specifically, a client transmits an API request (for example, a request for an API usable for displaying a weather forecast) to a server. Based on response information returned in response to the API request, predetermined information (weather forecast information) and the like are displayed.

In addition, JP 2013-021630 A discloses that an internal server (functioning as an API server) is provided in an MFP (image processing apparatus), and when a request (API request) for an API relating to job operation in the MFP is transmitted from a browser in the MFP apparatus to the internal server, response information (API response) is returned from the internal server to the browser. For example, it is possible to construct an operation screen of the MFP in the browser by using a page description language (HTML or the like) and an API (for example, an API relating to a job setting operation of the MFP and/or an API relating to a job execution operation thereof) such that it is possible to operate the MFP by using the operation screen.

The API server of the MFP (image processing apparatus) can also return response information in response to an API request from an external device (client) of the MFP as well as an API request from the browser in the MFP. In other words, it is also conceivable that the technique for executing the API request and the like from the above-described client (external client) to the web server is applied to the API server in the MFP (image processing apparatus).

More specifically, an API server is provided in the MFP. When a request (API request) for an API relating to job operation in the MFP is transmitted from the client (external client) to the MFP (API server), response information (API response) is returned from the API server to the client. The client performs an appropriate process (for example, a process of displaying received information) based on the response information. For example, it is possible to construct an operation screen of the MFP on (a display part of) the client by using a page description language (HTML or the like) and an API (for example, an API relating to a job setting operation of the MFP and/or an API relating to a job execution operation thereof) such that it is possible to operate the MFP by using the operation screen and the like displayed on the client. In other words, the client can perform job operation or the like in the MFP by using the API.

However, response information for an API request includes a wide variety of kinds of information, and may have a relatively large size. When such response information is constantly transmitted from the server to the client, problems may arise where, for example, a relatively long time will be required for processes, such as a receiving process and a process of analyzing received data, at the client.

### SUMMARY

An object of the present invention is to provide an image processing apparatus capable of efficiently transmitting response information to a transmission source device of a request for an API, and techniques related thereto.

To achieve the abovementioned object, according to an aspect of the present invention, an image processing apparatus reflecting one aspect of the present invention comprises: a hardware processor that accepts, from a client, a request for an API relating to the image processing apparatus, determines a client type of the client, which is a transmission source device of the request, based on history information of an API request from each client, and determines response information for the request for the API, based on the client type of the client; and a transmitter that transmits the determined response information to the client.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram showing a configuration of an image processing system according to a first embodiment;

FIG. 2 is a diagram showing functional blocks of an MFP;

FIG. 3 is a diagram showing a data table in which information on a plurality of APIs is specified;

FIG. 4 is a flowchart showing operation of the MFP;

FIG. 5 is a flowchart showing in detail a part of the operation shown in FIG. 4 (operation for determining a client type);

FIG. 6 is a flowchart showing in detail a part of the operation shown in FIG. 4 (operation for determining response information);

FIG. 7 is a diagram showing API usage history information;

FIG. 8 is a diagram showing a “response information determination table” for a “registered user information acquisition API”;

FIG. 9 is a diagram showing registered user information stored in the MFP;

FIG. 10 is a diagram showing a “response information determination table” for a “box document information acquisition API”;

FIG. 11 is a diagram showing an API data table according to a second embodiment;

FIG. 12 is a flowchart showing in detail a part of operation according to the second embodiment (operation for determining a client type);

FIG. 13 is a flowchart showing in detail a part of operation according to the second embodiment (operation for determining response information);

FIG. 14 is a diagram showing a parameter group relating to a copy job;

FIG. 15 is a diagram showing a “response information determination table” for a “job setting change API”;

FIG. 16 is a diagram showing other API usage history information;

FIG. 17 is a diagram showing an API data table according to a third embodiment;

FIG. 18 is a flowchart showing in detail a part of operation according to the third embodiment (operation for determining a client type);

FIG. 19 is a flowchart showing in detail a part of operation according to the third embodiment (operation for determining response information); and

FIG. 20 is a diagram showing a data table defining a correspondence relationship between device identification information and client type information of each client.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

<1-1. System Configuration>

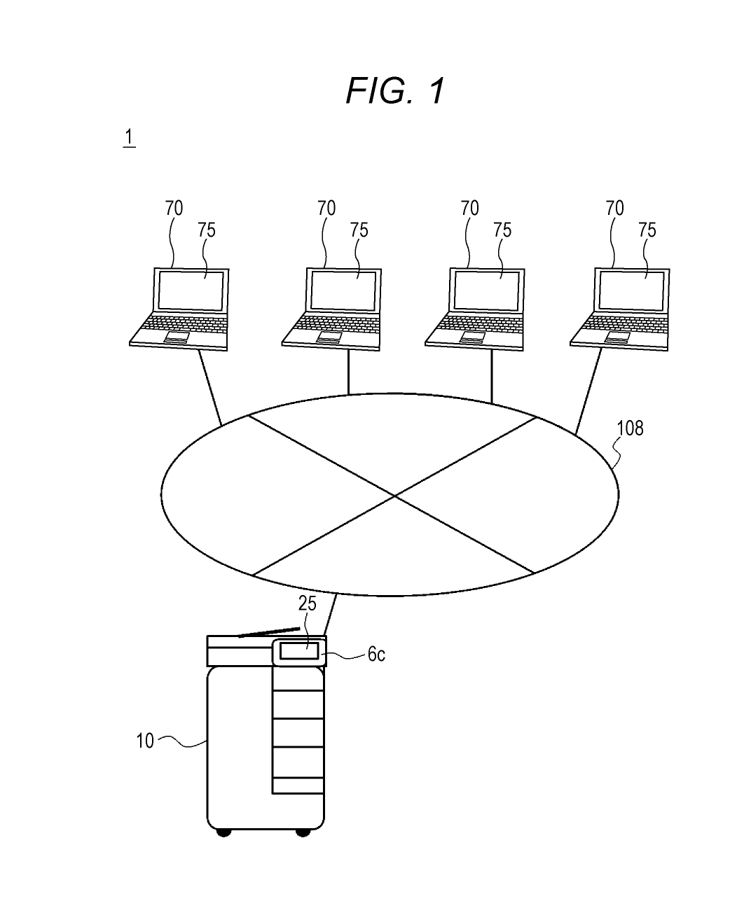

FIG. 1 is a schematic diagram showing a configuration of an image processing system 1 according to a first embodiment of the present invention. As shown in FIG. 1, the image processing system 1 includes an MFP 10 (image processing apparatus) and a client computer 70. The client computer 70 is also referred to as an external device of the MFP 10.

The MFP 10 and the client computer (also simply referred to as a client) 70 are connected to each other via a network 108. The network 108 includes a local area network (LAN), the Internet, and the like. Furthermore, either wired connection or wireless connection may be adopted as the connection mode with respect to the network 108.

The client 70 may access the MFP 10 from inside the LAN, or may access the MFP 10 from outside the LAN via a router or the like.

<1-2. Configuration of MFP 10>

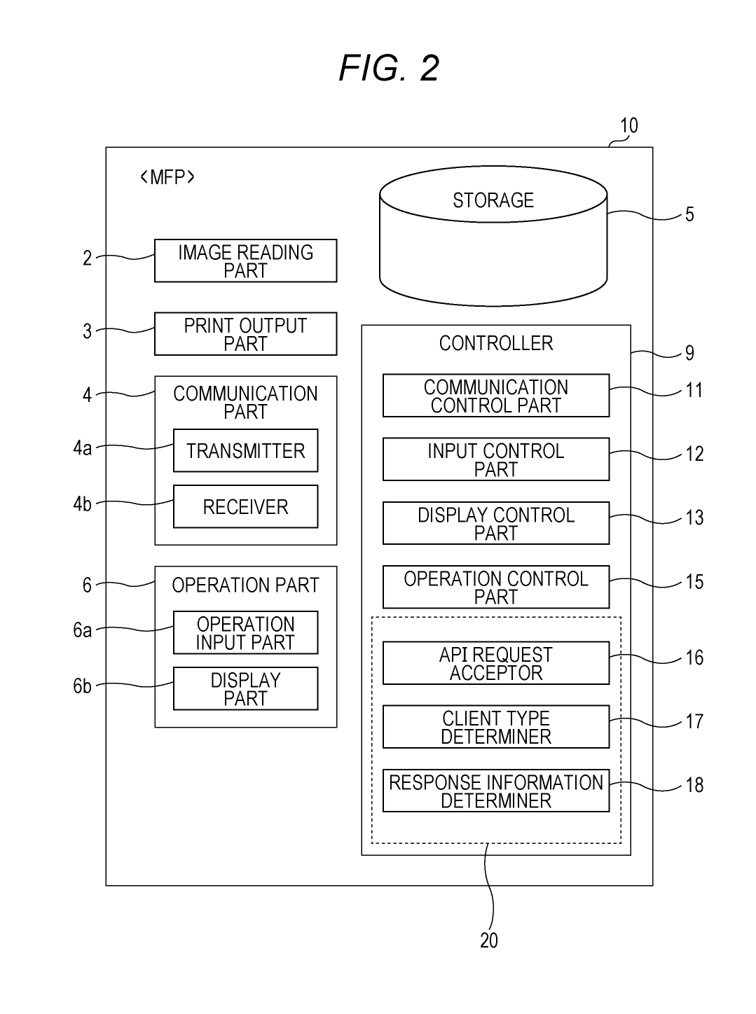

FIG. 2 is a diagram showing functional blocks of the multi-function peripheral (MFP) 10.

The MFP 10 is an apparatus (also referred to as a complex machine) provided with a scanning function, a copy function, a facsimile function, a box storage function, and the like. Specifically, as shown in the functional block diagram of FIG. 2, the MFP 10 includes an image reading part 2, a print output part 3, a communication part 4, a storage 5, an operation part 6, a controller 9, and the like. The MFP 10 implements various functions by causing these respective parts to operate in a complex manner. It should be noted that the MFP 10 is also referred to as an image processing apparatus, an image forming apparatus, or the like.

The image reading part 2 is a processing part that optically reads (that is, scans) a document placed at a predetermined position of the MFP 10, and generates image data (also referred to as a document image or a scanned image) of the document. This image reading part 2 is also referred to as a scanning part.

The print output part 3 is an output part that prints and outputs an image on various media including paper based on data relating to an object to be printed. The MFP 10 is also referred to as an electrophotographic printer (full-color printer or the like). The print output part 3 has various hardware mechanisms such as an exposure part, a developing part, a transfer part, and a fixing part.

The communication part 4 is a processing part capable of performing facsimile communication via a public line or the like. Furthermore, the communication part 4 can also perform network communication via the network 108. In the network communication, for example, various protocols including the Transmission Control Protocol/Internet Protocol (TCP/IP) are used. By using the network communication, the MFP 10 can exchange various data with a desired party (for example, the client 70). The communication part 4 includes a transmitter 4a that transmits various data and a receiver 4b that receives various data.

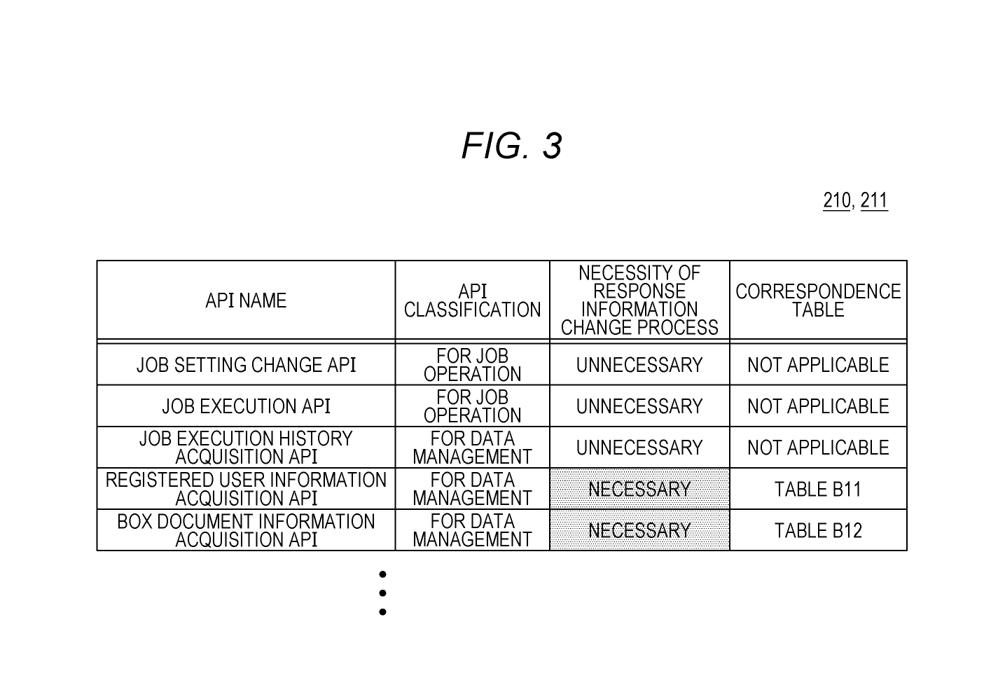

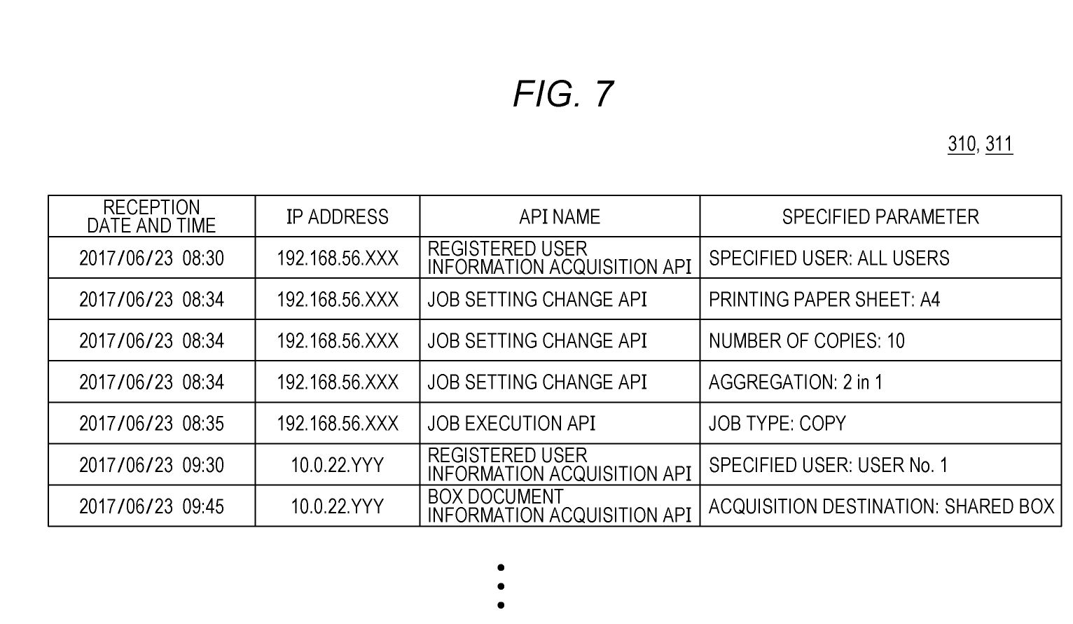

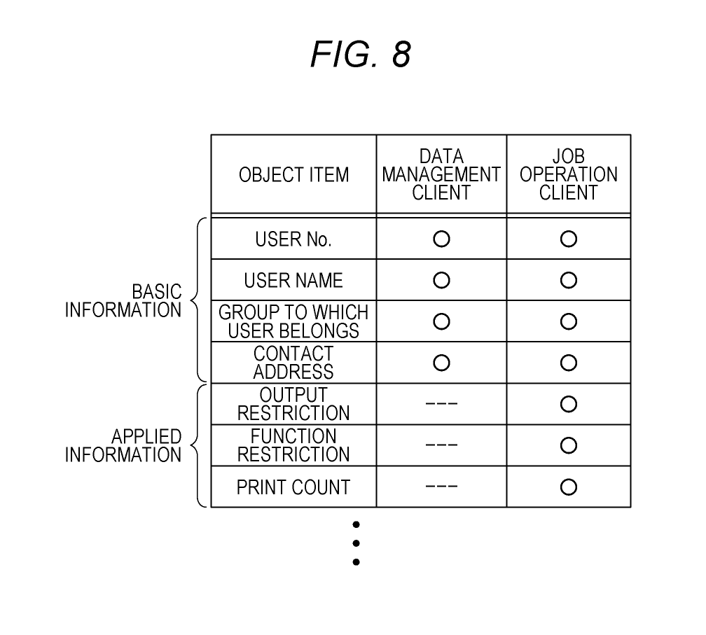

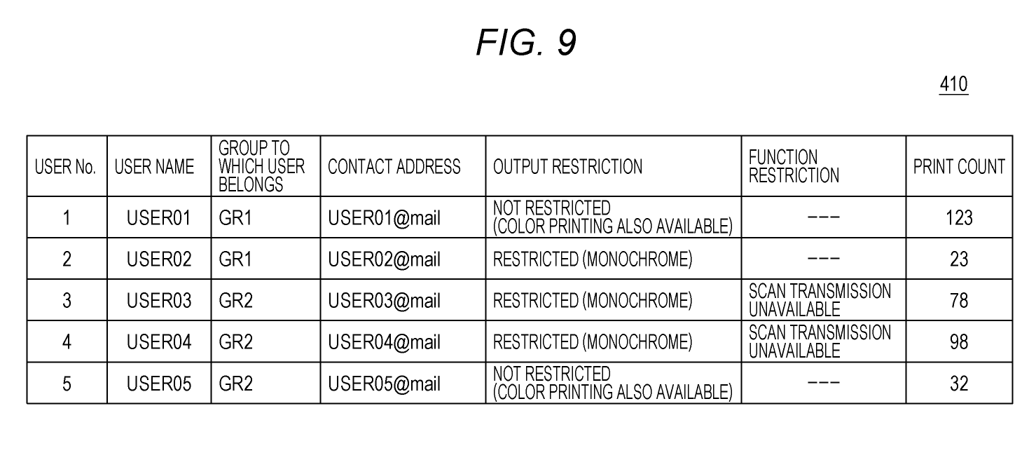

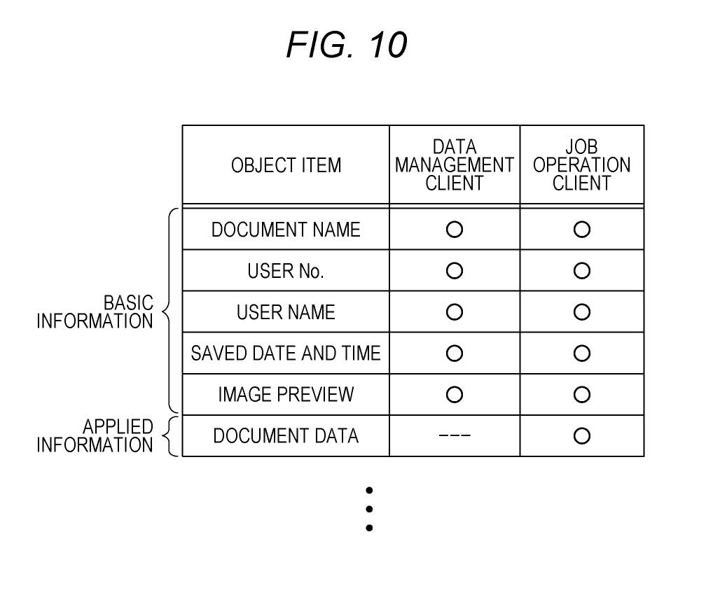

The storage 5 includes a storage device (nonvolatile storage device) such as a hard disk drive (HDD). The storage 5 stores API information 210 (FIG. 3), API usage history information 310 (FIG. 7), information for determination of response information (tables B11 (FIG. 8), B12 (FIG. 10), . . . ), registered user related information 410 (FIG. 9), and the like, to be described below.

The operation part 6 includes an operation input part 6a that accepts an operation input to the MFP 10, and a display part 6b that displays and outputs various kinds of information. The MFP 10 is provided with a substantially plate-like operation panel part 6c (see FIG. 1). The operation panel part 6c has a touch panel 25 (see FIG. 1) on its front side. The touch panel 25 includes a liquid crystal display panel with a piezoelectric sensor and the like embedded therein. The touch panel 25 can display various kinds of information, and accept an operation input from an operator. For example, various screens (including button images and the like) such as a menu screen are displayed on the touch panel 25. An operator can, for example, change various setting details of the MFP 10 by pressing buttons (buttons represented by button images) virtually arranged in the touch panel 25. The touch panel 25 also functions as a part of the display part 6b as well as a part of the operation input part 6a.

The controller (control part) 9 is a control device incorporated in the MFP 10, which comprehensively controls the MFP 10. The controller 9 is configured as a computer system that includes a CPU, various semiconductor memories (RAM (volatile memory) and ROM (nonvolatile memory)), and the like. The controller 9 implements various processing parts by executing, in the CPU, a predetermined software program (hereinafter, also simply referred to as a program) stored in the ROM (for example, EEPROM (registered trademark)). It should be noted that the program (specifically, a program module group) may be recorded in a portable recording medium such as a USB flash drive, read from the recording medium, and installed on the MFP 10. Alternatively, the program may be downloaded via a network or the like, and installed on the MFP 10.

Specifically, by executing the program, the controller 9 implements various processing parts including a communication control part 11, an input control part 12, a display control part 13, an operation control part 15, an API request acceptor 16, a client type determiner 17, and a response information determiner 18, as shown in FIG. 2.

The communication control part 11 is a processing part that controls communication operation with another device (the client 70 or the like). For example, in cooperation with the communication part 4 and the like, the communication control part 11 receives a print command and the like from the client 70.

The display control part 13 is a processing part that controls display operation in the display part 6b. For example, the display control part 13 causes the display part 6b to display an operation screen or the like for operating the MFP 10.

The input control part 12 is a control part that controls operation of an operation input to the operation input part 6a. For example, the input control part 12 controls operation of accepting an operation input to the operation screen.

The operation control part 15 is a control part that controls print output operation, scanning operation, and the like in the MFP 10.

The API request acceptor 16 is a processing part that accepts a request for an application programming interface (API) relating to the MFP 10 from the client 70 or the like. The API request acceptor 16 also performs an analysis process for analyzing the content of the request (API request).

The client type determiner 17 is a processing part that determines a client type (to be described below) of a client (client device) that is a transmission source device of the API request.

The response information determiner 18 is a processing part that determines response information (to be described below) for an API request, based on the client type of the transmission source device of the API request. More specifically, from a group of candidates for response information for the API request, the response information determiner 18 determines (designates) information corresponding to the client type of the transmission source device of the API request, as response information to be actually returned to the transmission source device. When response information is determined as described above, the response information is transmitted to the client as the transmission source device, by the response information determiner 18, the communication control part 11, the communication part 4, and the like.

The API request acceptor 16, the client type determiner 17, and the response information determiner 18 function as an API server part 20 (a server processing part that performs processes on the server side in response to an API request from a client).

In this manner, the above-described various operations are performed by execution of the software program mainly in the CPU of the controller 9. However, the present invention is not limited thereto, and the above-described various operations may be performed by use of dedicated hardware or the like provided in the MFP 10 (specifically, inside or outside the controller 9). For example, all or some of the various processing parts such as the communication control part 11, the input control part 12, the display control part 13, the operation control part 15, the API request acceptor 16, the client type determiner 17, and the response information determiner 18 may be implemented by use of one or a plurality of pieces of dedicated hardware.

<1-3. Configuration of Client Computer 70>

The client computer 70 includes an information processing apparatus such as a personal computer with a physical configuration that includes a controller (including a CPU, a semiconductor memory, and the like), a storage (HDD, SSD, and the like.), a communication part, an operation part, and the like. However, the client 70 is not limited to a personal computer, and may be a smartphone, a tablet terminal, or the like.

The controller of the client 70 implements various processing parts by executing, in the CPU, a predetermined program (such as a printer driver).

One or a plurality of application programs (hereinafter, also simply referred to as applications) has been installed on each client computer (hereinafter, also simply referred to as a client) 70.

Each application performs, for example, a process of accepting, from each user, an instruction for activating a corresponding service. Subsequently, the client 70 transmits a request (API request) for an API (API relating to the MFP 10) to the MFP 10, and receives response information for the API request from the MFP 10 (the API server part 20 and the like). Then, the client 70 performs various services by using various kinds of information included in the response information.

Examples of an application in the client 70 include an application relating to job operation in the MFP 10 (“job operation application”). With the “job operation application”, processes, such as a process of changing the setting of a job and a process of executing the job, are performed. More specifically, an image for operation (for example, a simulated image of a panel image displayed on the operation panel part 6c of the MFP 10 or a unique image not depending on the panel image) of the MFP 10 is displayed on a display part 75 (see FIG. 1) of the client computer 70, so that an input of an instruction (a job start instruction or the like) is accepted from a user. Based on the input of the instruction, a command such as a command (execution command) to start a job in the MFP 10 is issued to the MFP 10. Furthermore, when executing a job for a user, the application acquires various setting values relating to the job from the MFP 10, and displays some or all of the various setting values in the image for operation on the client 70, as necessary. In addition, the application accepts a setting change regarding the setting values from the user, and transmits details of the setting change to the MFP 10. Moreover, the MFP 10 transmits, to the client 70, setting values (setting details) relating to a plurality of setting items including setting items changed in settings. Then, the client computer 70 displays information (setting details and the like) on some or all of the plurality of setting items.

In addition, an application (“data management application”) for performing management and the like of data relating to the MFP 10 can be cited as another example of an application in the client 70. With the “data management application”, there are performed processes of, for example, collecting and managing various kinds of information (data) relating to the MFP 10.

Various APIs (APIs for the MFP) as described below are used in these applications. It should be noted that each application is executed by use of one or a plurality of APIs.

For example, in the “job operation application”, there are used an API (“job setting change API”) for performing processes of acquiring and/or changing setting values for a job, and an API (“job execution API”) for issuing a job execution command and the like. It should be noted that the “job execution API” may be an API capable of issuing not only a job execution command but also, for example, a command to stop job execution and/or a command to restart job execution.

By use of the “job setting change API”, the client 70 can issue a command to change settings in a job to the MFP 10, and receive one or a plurality of setting values changed according to the setting change command, from the MFP 10.

For example, the client 70 can issue, to the MFP 10, a setting change command to change the size of a printing paper sheet from “A4” to “A3” by specifying a parameter (“printing paper sheet: A3”) in the “job setting change API”. In addition, the MFP 10 returns, to the client 70, response information including setting values of a plurality of setting items (also including setting items (for example, “magnification ratio”) other than a specified parameter). More specifically, when the setting value of another setting item “magnification ratio” is set to “automatic”, an actual setting value of the “magnification ratio” is changed from “100%” to “144%” according to a change in settings of “printing paper sheet size” (“A4”→“A3”). At this time, the client 70 receives, from the MFP 10, response information including the changed size (“A3”) of a printing paper sheet and the (actual) value (“144%”) of the magnification ratio after the change of the size of a paper sheet. As a result, the client 70 can find setting values of the plurality of setting items after the change of settings. It should be noted that an instruction for changing settings is input, and setting values after the setting change are displayed, by use of the image for operation (image for operation of the MFP 10) in the display part of the client 70.

Additionally, by use of the “job execution API”, the client 70 can issue a job execution command and the like to the MFP 10.

Furthermore, in the “data management application”, there are used, for example, an API (“job execution history acquisition API”) for acquiring job execution history information, an API (“registered user information acquisition API”) for acquiring information on registered users, and an API (“box document information acquisition API”) for acquiring information on a box document. It should be noted that the “box” refers to a folder (storage area) provided in the storage 5 of the MFP 10.

For example, by using the “registered user information acquisition API”, the client 70 can acquire, from the MFP 10, user information of all users (or a specified user) of the MFP 10.

Here, both types of applications “job operation application” and “data management application” have not necessarily been installed on each client 70. In other words, each client 70 does not necessarily use both types of applications.

For example, a client 70 (for example, 70b) does not have the “job operation application” installed, but has (only) the “data management application” installed. Such a client is a type of client that does not perform “job operation” (job operation in the MFP 10). In other words, such a client is engaged exclusively in “data management”, and is also referred to as a “data management client”.

Meanwhile, another client 70 (for example, 70a) may have only the “job operation application” installed (or may have both “data management application” and “job operation application” installed). Such a client is a type of client that performs “job operation” (job operation in the MFP 10), and is also referred to as a “job operation client”.

In the present embodiment, as will be described below, the client type (“job operation client”/“data management client”) of the transmission source device (client) of an API is determined based on the job execution history information (API usage history information 310 (see FIG. 7)).

<1-4. Types of APIs>

FIG. 3 is a diagram showing a data table 210 (211) in which information on a plurality of APIs is specified. The data table (also referred to as an API data table or API information) 210 is stored in advance in the MFP 10. The data table 210 of FIG. 3 shows, for example, a plurality of APIs that can be used in the present system.

In FIG. 3, the “job setting change API”, “job execution API”, “job execution history acquisition API”, “registered user information acquisition API”, “box document information acquisition API”, and the like are listed as examples (see the column “API name” of the data table 210).

Among them, the “job setting change API” and “job execution API” are APIs to be used in an application (“job operation application”) relating to job operation in the MFP 10, and are thus classified as “job operation APIs” (also referred to as job type APIs).

Meanwhile, the “job execution history acquisition API”, “registered user information acquisition API”, and “box document information acquisition API” are APIs to be used in an application (“data management application”) that performs management and the like of data relating to the MFP 10, and are thus classified as “data management APIs” (also referred to as data type APIs).

The data table 210 of FIG. 3 describes whether each API is classified as the “job operation API” or “data management API” in the column “API classification”.

Furthermore, in the present embodiment, “necessity of a response information change process (determination process)” is defined in advance for each of a plurality of APIs, as shown in FIG. 3. Based on the definition, the necessity of a response information change process is determined for each API. In addition, information on a table (“correspondence table”) to be used as a “response information determination table” is specified for an API defined, in advance, as an API that requires a response information change process (“necessity of a response information change process”=“necessary”).

For example, in FIG. 3, the “job execution history acquisition API”, “job setting change API”, and “job execution API” are defined as APIs that require no response information change process (a response information change process is “unnecessary”). Meanwhile, the “registered user information acquisition API” and “box document information acquisition API” are defined as APIs that require a response information change process. Moreover, the table B11 (see FIG. 8) is defined as the “response information determination table” to be used for the “registered user information acquisition API”. The table B12 (see FIG. 10) is defined as the “response information determination table” to be used for the “box document information acquisition API”.

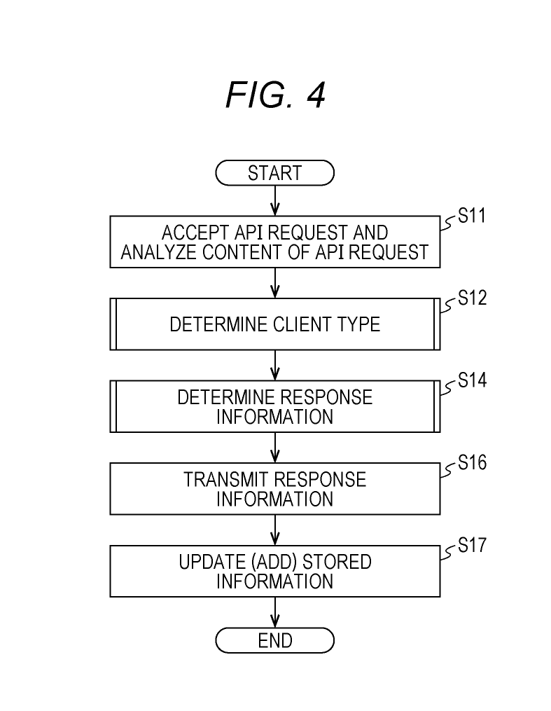

It should be noted that in the present embodiment, a response information determination process (step S14 (see FIG. 4)) and the like are performed only for some APIs, among a plurality of APIs, which are defined in advance as APIs that require a response information change process (“necessity of a response information change process (determination process)”=“necessary”).

In addition, an aspect in which each API is common to a plurality of job types is mainly cited here as an example. For example, the “job setting change API” is common to a plurality of job types (copy job, scan job, facsimile job (facsimile transmission job), print job (box print job), and the like). However, the present invention is not limited thereto. Each API may be an API provided for each job type (an API unique to each of a plurality of job types). For example, the “job setting change API” may be separately provided as a plurality of APIs dedicated to corresponding jobs (“copy job setting change API”, “scan job setting change API”, “facsimile transmission job setting change API”, “box print job setting change API”, and the like).

<1-5. Operation>

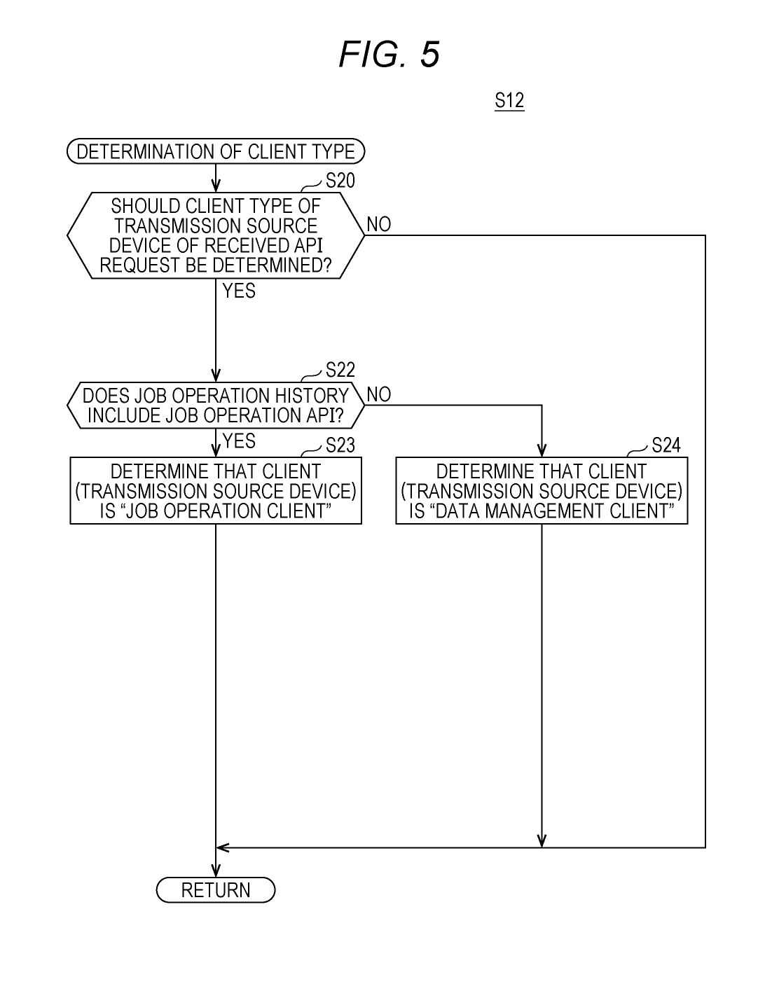

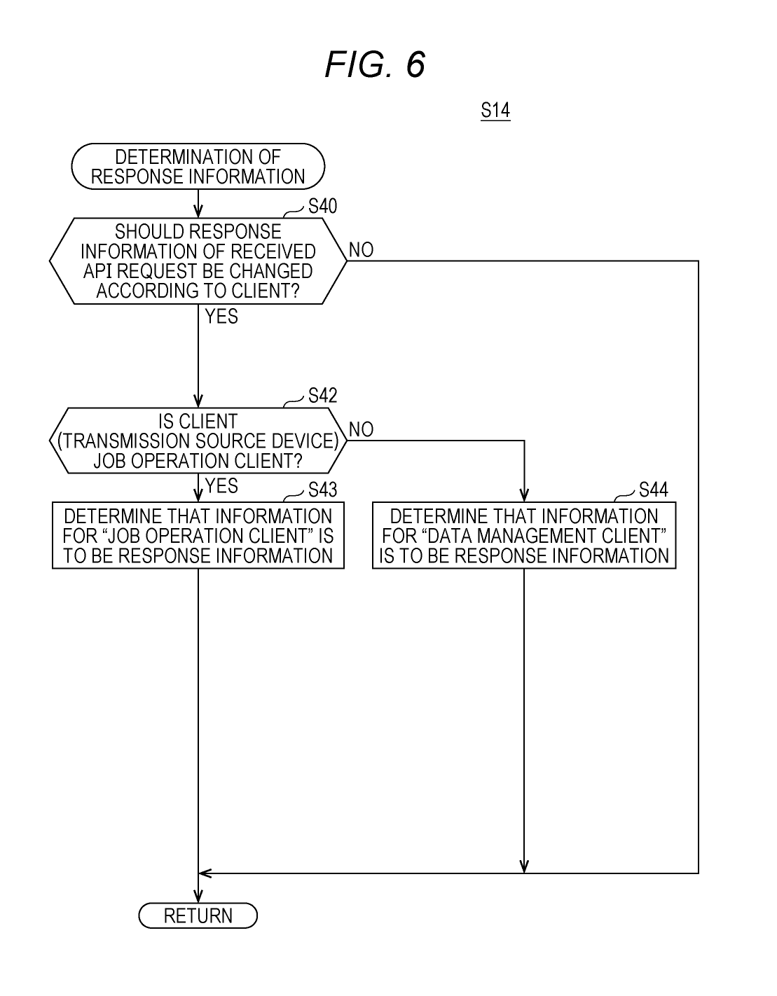

FIG. 4 is a flowchart showing operation of the MFP 10. FIG. 5 is a flowchart showing in detail a part of the operation shown in FIG. 4 (step S12). FIG. 6 is a flowchart showing in detail another part of the operation shown in FIG. 4 (step S14). In addition, FIG. 7 is a diagram showing information (API usage history information) 310 (311) on the usage history of APIs.

The usage history information 310 of FIG. 7 shows the usage history of APIs used before the operations shown in FIGS. 4 to 6 are started. More specifically, a record of each API having been used by each of a plurality of clients is shown. For each of a plurality of APIs used, the usage history information 310 includes records of a reception date and time of an API request, identification information (IP address in this case) of a transmission source device of the API request, an API name (“registered user information acquisition API”, “job setting change API”, and the like), specified parameters in an API (“printing paper sheet: A4”, “number of copies: 10”, “aggregation: 2 in 1”, . . . ), and the like. The usage history information 310 is stored in the MFP 10.

Operation of the present system will be described below with reference to FIGS. 4 to 6, with a focus on operation of the MFP 10. It should be noted that the operation shown in FIG. 4 is performed each time an API request is accepted.

In step S11 of FIG. 4, the MFP 10 receives (accepts) a request (API request) for an API relating to the MFP 10 from the client 70 (for example, 70a), and analyzes the content of the API request.

<Step S12: Determination of Client Type>

Next, in step S12, the MFP 10 determines a client type of the client 70 (70a) which is a transmission source device of the API request.

In the present embodiment, a client type of the transmission source device of the API request is determined based on the usage history information 310 (311) of APIs (see FIG. 7).

FIG. 5 is a flowchart showing the detailed operation of step S12. The operation of step S12 will be described below in detail with reference to FIG. 5 and others.

In step S20 (FIG. 5), the MFP 10 determines whether to determine a client type of the transmission source device (client 70) of the received API. Specifically, the MFP 10 refers to the column “necessity of a response information change process” in the API data table 210 (211) (FIG. 3), and determines “whether the received API is an API that requires a response information change process (determination process)”.

When the API is an API that requires no response information change process, it is determined that it is not necessary to determine a client type of the transmission source device (client 70) of the API. Then, the process of step S12 is terminated.

Meanwhile, when the API is an API that requires a response information change process, it is determined that a client type of the transmission source device (client 70) of the API should be determined. Then, the process proceeds to step S22.

For example, when the received API is one of the “job setting change API”, “job execution API”, “job execution history acquisition API”, and the like, a “change of response information” is defined as “unnecessary” (see FIG. 3). Thus, it is determined that it is not necessary to determine a client type of the transmission source device of the API. In this case, the process shown in FIG. 5 is terminated.

Meanwhile, when the received API is one of the “registered user information acquisition API”, “box document information acquisition API”, and the like, a “change of response information” is defined as “necessary” (see FIG. 3). Thus, it is determined that a client type of the transmission source device of the API should be determined. Then, the process proceeds to step S22.

In steps S22 to S24, it is determined whether a client type of the transmission source device is the “job operation client” or “data management client”.

In step S22, it is determined whether the API usage history information 310 includes a record of the “job operation API” having been used by the transmission source device (a usage record of an API classified as the “job operation API” which is one of the API classifications). In other words, it is determined whether the history information (API usage history information 310) includes an execution record of an “API relating to job operation” as a past API request from the transmission source device. Then, based on the determination result, it is determined whether the transmission source device is the “job operation client” or “data management client”. In this manner, the client type determination process is performed based on a criterion D1 as to whether the API usage history information 310 includes a record of the “job operation API” having been used by the transmission source device.

Specifically, when the API usage history information 310 includes a record of the “job operation API” having been used by the transmission source device, it is determined that the transmission source device is the “job operation client” (step S23). Meanwhile, when the API usage history information 310 includes no record of the “job operation API” having been used by the transmission source device, it is determined that the transmission source device is the “data management client” (step S24).

For example, assume that the transmission source device has an IP address “192.168.56.XXX”. Then, the API usage history information 310 shown in FIG. 7 includes a record of the “job setting change API” having been used by a client with the IP address, and a record of the “job execution API” having been used by the client with the IP address. Here, the “job setting change API” and “job execution API” are classified as “job operation APIs” as described above (see FIG. 3). Therefore, it is determined that the API usage history information 310 includes records of the “job operation APIs” having been used by the transmission source device. Then, it is determined that the transmission source device is the “job operation client” (step S23).

Meanwhile, assume that a transmission source device has an IP address “10.0.22.YYY”. Then, the API usage history information 310 includes records of the “data management APIs” (specifically, “registered user information acquisition API” and “box document information acquisition API”) having been used by a client with the IP address. However, the API usage history information 310 includes no record of the “job operation API” having been used by the client. In this case, it is determined that the API usage history information 310 includes no record of the “job operation API” having been used by the transmission source device. Then, it is determined that the transmission source device is the “data management client” (step S24).

As described above, the “client type determination process (of the transmission source device)” in the first embodiment is performed based on the “API classification” information (see FIG. 3) (“job operation API”/“data management API”) of an API recorded as having been used by the transmission source device (see, for example, the column “API name” in the API usage history information 310 shown in FIG. 7).

<Step S14: Determination of Response Information>

Next, in step S14 (FIG. 4), “response information” (information to be returned in response to the API request) for the API request received in step S11 is determined based on the client type determined in step S12.

FIG. 6 is a flowchart showing the detailed operation of step S14. The operation of step S14 will be described below in detail with reference to FIG. 6 and others.

In step S40 (FIG. 6), the MFP 10 determines whether to change response information of the received API according to the client type. Specifically, the MFP 10 refers to the column “necessity of a response information change process” in the API data table 210 (211) (FIG. 3), and determines “whether the received API is an API that requires a response information change process”.

When the API is an API that requires no response information change process, it is determined that it is not necessary to change the response information of the API according to the client type. Then, the process of step S14 is terminated.

Meanwhile, when the API is an API that requires a response information change process (determination process), it is determined that the response information of the API should be changed (determined) according to the client type. Then, the process proceeds to step S42.

For example, when the received API is one of the “job setting change API”, “job execution API”, “job execution history acquisition API”, and the like, the “necessity of a response information change process” is defined as “unnecessary” (see FIG. 3). Thus, it is determined that it is not necessary to change the response information of the API according to the client type. Meanwhile, when the received API is one of the “registered user information acquisition API”, “box document information acquisition API”, and the like, the “necessity of a response information change process” is defined as “necessary” (see FIG. 3). Thus, it is determined that the response information of the API should be changed according to the client type.

In addition, in step S42, it is determined whether the transmission source device of the API is the “job operation client” or “data management client”. Then, according to the determination result, the response information of the API is determined.

Specifically, when the transmission source device of the API is the “job operation client”, it is determined that information for the “job operation client” is to be the response information (step S43). Meanwhile, when the transmission source device of the API is the “data management client”, it is determined that information for the “data management client” is to be the response information (step S44). Here, the information for the “job operation client” and the information for the “data management client” are specified in advance for each API.

<Response Information Regarding “Registered User Information Acquisition API”>

Here, assume that, for example, the “registered user information acquisition API” has been received in step S11.

First, the data table 210 (211) shown in FIG. 3 is referred to.

In this case, the data table 211 specifies that the data table B11 (see also FIG. 8) should be referred to as the response information determination table relating to the “registered user information acquisition API”. The MFP 10 refers to the data table B11 in accordance with the description.

With respect to the “registered user information acquisition API”, the data table B11 provides the information (specifically, information items) for the “job operation client”, and the information (information items) for the “data management client”. It should be noted that the data table B11 is stored in advance in the MFP 10.

Here, the “registered user information acquisition API” is an API that acquires, for example, information on registered users as described above. With the “registered user information acquisition API”, it is possible to acquire information of a plurality of information items regarding a registered user (“user No.”, “user name”, “group to which user belongs”, “contact address”, “output restriction”, “function restriction”, “print count”, and the like) (see FIG. 8). The Information (details) of the plurality of information items is also referred to as a group of candidates for response information.

Here, the “user No.” is an information item representing a number for a user. The “user name” is an information item representing a name of the user. In addition, the “group to which user belongs” is an information item representing a group (groups GR1, GR2, and the like) to which the user belongs. Furthermore, the “contact address” is an information item representing a contact address (e-mail address) of the user.

Moreover, the “output restriction” is an information item representing a restriction (user restriction) on an output color (full-color output) for the user. Regarding the item “output restriction”, there is provided information representing either “not restricted (both monochrome output and full-color output are available)” or “restricted (only monochrome output is available) (full-color output is unavailable)” (see also FIG. 9). When the output restriction is imposed on a user, the user cannot cause the MFP 10 to perform full-color printout.

In addition, the “function restriction” is an information item representing a restriction on functions available to the user. Regarding the item “function restriction”, there is provided information as to either “not restricted” or “restricted (scan transmission unavailable)”. When the “function restriction” is imposed on a user, the user cannot use the scan transmission function.

Moreover, the “print count” is an information item representing the number of output sheets printed by the user (the number of sheets printed out thus far). In the item “print count”, there is provided information on the number of sheets printed by the user (“123 sheets”, “23” sheets, or the like) within a predetermined period of time. When the “print count” for a user reaches an upper limit value (prescribed value), the user cannot cause the MFP 10 to perform a print output process thereafter.

FIG. 9 is a diagram showing a data table (registered user related information) 410 that stores the above-described information for each user. The data table 410 shown in FIG. 9 provides each information on the above-described plurality of setting items for each of a plurality of registered users U1 to U5, and the like.

Referring again to FIG. 8. Among pieces of information of the plurality of items, the “data management client” often uses basic information (for example, information of the “user No.”, “user name”, “group to which user belongs”, and “contact address”). Meanwhile, among the pieces of information of the plurality of items, the “job operation client” often uses not only the basic information but also other information (specifically, information to be used for job operation) (for example, information such as the “output restriction”, “function restriction”, and “print count”) (also referred to as applied information or non-basic information).

Therefore, in the present embodiment, when it is determined that the transmission source device of the API (“registered user information acquisition API”) is the “data management client”, it is determined that only the “basic information”, which is used for both data management and job operation, is to be “response information” for the API, out of the group of candidates for response information for the API (step S44). More specifically, with reference to the data table B11 (response information determination table), it is determined that only the information items (“user No.”, “user name”, “group to which user belongs”, and “contact address”) relating to the “basic information” are to be information items of the response information. In addition, information details (entity data) corresponding to the information items are acquired (determined) as the content of the response information.

Meanwhile, when it is determined that the transmission source device of the API (“registered user information acquisition API”) is the “job operation client”, it is determined that not only the “basic information” but also the “applied information”, which is not used in data management but used in job operation, are to be the “response information” for the API, out of the group of candidates for response information for the API (step S43). More specifically, it is determined that both of the information items relating to the “basic information” and the information items relating to the “applied information” (“output restriction”, “function restriction”, “print count”, and the like) (all items relating to the group of candidates for response information) are to be the information items of the response information. In addition, information details corresponding to the information items are acquired (determined) as the content of the response information.

<Response Information Regarding “Box Document Information Acquisition API”>

Next, assume that the “box document information acquisition API” has been received in step S11. In this case, based on the data table 210 (211) shown in FIG. 3, it is determined that the data table B12 should be referred to.

With respect to the “box document information acquisition API”, the data table B12 (see FIG. 10) provides the information (specifically, information items) for the “job operation client” and the information (information items) for the “data management client”. It should be noted that the data table B12 is stored in advance in the MFP 10.

Here, the “box document information acquisition API” is an API for acquiring, for example, information on a box document as described above. With the “box document information acquisition API”, it is possible to acquire information of a plurality of information items regarding a document in a box (“document name”, “user No. (of a document creation user)”, “user name (of a document creation user)”, “saved date and time (of a document)”, “image preview (of a document)”, “document data (itself)”, and the like) (see FIG. 10). The Information (details) of the plurality of information items is also referred to as a group of candidates for response information.

Among pieces of information of the plurality of items, the “data management client” often uses basic information (for example, information on the “document name”, “user No. (of a document creation user)”, “user name (of a document creation user)”, “saved date and time (of a document)”, and “image preview (of a document)”). Meanwhile, among the pieces of information of the plurality of items, the “job operation client” often uses not only the basic information but also other information (specifically, information to be used for job operation) (for example, information such as the “document data (itself)”) (also referred to as applied information or non-basic information).

Therefore, in the present embodiment, when it is determined that the transmission source device of the API (“box document information acquisition API”) is the “data management client”, it is determined that only the “basic information”, which is used for both data management and job operation, is to be “response information” for the API, out of the group of candidates for response information for the API (step S44). More specifically, in step S14, with reference to the data table B12 (FIG. 10), it is determined that only the information items (“document name”, “user No.”, “user name”, “saved date and time”, and “image preview”) relating to the “basic information” are to be information items of the response information. In addition, information details corresponding to the information items are acquired (determined) as the content of the response information.

Meanwhile, when it is determined that the transmission source device of the API (“box document information acquisition API”) is the “job operation client”, it is determined that not only the “basic information” but also the “applied information”, which is not used in data management but used in job operation, are to be the response information for the API, out of the group of candidates for response information for the API (step S43). More specifically, it is determined that both of the information items relating to the “basic information” and the information items relating to the “applied information” (“document data (itself)” and the like) (all items relating to the group of candidates for response information) are to be the information items of the response information. In addition, information details corresponding to the information items are acquired (determined) as the content of the response information.

As described above, the process of step S14 is performed.

<Step S16 and Subsequent Steps, and Others>

Next, in step S16 (FIG. 4), the response information determined in step S14 is transmitted from the MFP 10 to the client 70. In this manner, a response (HTTP response or the like) to the API request (HTTP request or the like) from the client 70 to the MFP 10 is transmitted from the MFP 10 to the client 70. It should be noted that the HTTP response may include, for example, data in the XML format or JSON (JavaScript (registered trademark) Object Notation) format.

Additionally, in step S17, the API usage history information 310 is updated.

Subsequently, the client 70 having received the response information performs various processes (a display process and the like) by using the response information.

For example, in the case where the client 70 as the job operation client receives response information regarding the “registered user information acquisition API”, and acquires information regarding an output restriction on a specific user (“restricted” (full color prohibited)), it is possible to perform a process of, for example, invalidating a button for setting “full color” on the operation screen (operation screen for the specific user to operate the MFP 10) displayed on the client 70.

According to the operation as described above, the MFP 10 accepts an API request relating to the MFP 10 from the client (transmission source device) 70, and determines a client type (“job operation client”/“data management client”) of the transmission source device 70 of the API request. Then, the MFP 10 determines response information for the API request based on the client type.

Specifically, when the transmission source device is the “data management client”, it is determined that only the basic information (information to be used for both data management and job operation) is to be response information for the API request, out of the group of candidates for response information for the API request. Meanwhile, when it is determined that the transmission source device is the “job operation client”, it is determined that not only the basic information but also the applied information (information which is not used in data management but used in job operation) are to be the response information for the API request. Then, the MFP 10 transmits the determined response information to the transmission source device 70.

Therefore, the MFP 10 can efficiently transmit information to a client (transmission source device) as the request source of an API. In particular, when the transmission source device is the “data management client”, only the basic information (that is, a relatively small amount of data) is transmitted as response information for the API request. Therefore, by narrowing down data to be transmitted and received, it is possible to prevent delay and the like in transmission, and achieve high responsiveness (high operability).

Furthermore, in particular, response information for an API request is automatically determined according to a client type automatically determined based on the API usage history information 310. Therefore, it is possible to flexibly and appropriately determine response information as compared with the case where response information is determined based on a client type allocated to an IP address in a fixed manner (to be described below).

### 2. Second Embodiment

A second embodiment is a variation of the first embodiment. The second embodiment will be described below with a focus on differences from the first embodiment.

In the first embodiment described above, it is determined, in step S12, whether a client type of a transmission source device of an API request is the “job operation client” or “data management client”. This determination process is performed based on the criterion D1 (also referred to as a first criterion) as to whether the API usage history information 310 includes a record of the “job operation API” having been used by the transmission source device. In addition, when the transmission source device is the “data management client”, it is determined that only the basic information, which is used for both data management and job operation, is to be response information for the API request. Meanwhile, when it is determined that the transmission source device is the “job operation client”, it is determined that not only the basic information but also the applied information (information which is not used in data management but used in job operation) are to be the response information for the API request.

In contrast, in the second embodiment, it is determined, in step S12, whether a client type of a transmission source device of an API request is a “basic operation client” (to be described below) or “applied operation client” (to be described below). This determination process is performed based on a criterion D2 (also referred to as a second criterion) as to whether a “non-basic level (application level) parameter” is specified in a record of a “job operation API” having been used by the transmission source device. Furthermore, in step S14, when the transmission source device is the “basic operation client”, it is determined that only a parameter group of a “basic level” is to be response information for the API, out of a group of candidates for response information for the API. Meanwhile, when the transmission source device is the “applied operation client”, it is determined that not only the parameter group of the “basic level” but also a parameter group of the “application level” are to be response information for the API.

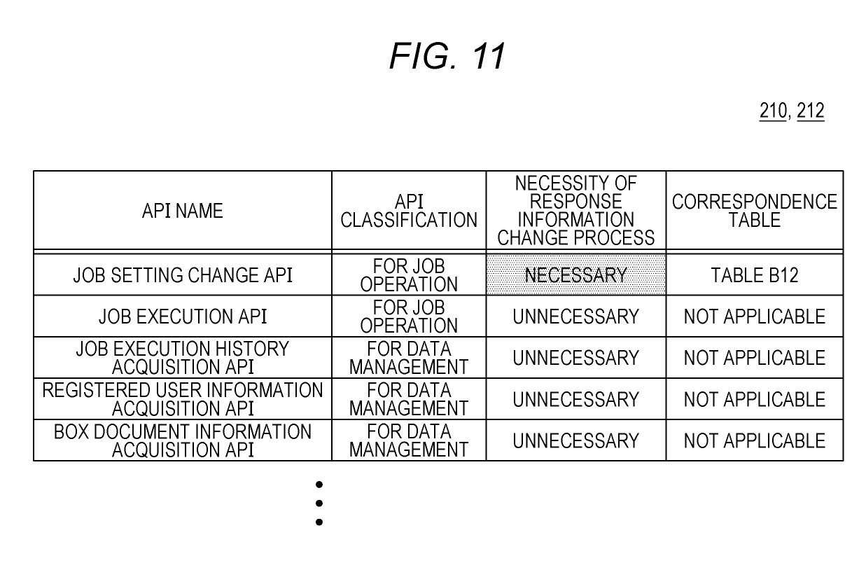

In the second embodiment, a data table 210 (212) shown in FIG. 11 is used in place of the data table 210 (211) shown in FIG. 3. As can be seen from comparison with the data table 211 of FIG. 3, “necessity of a response information change process” for a “job setting change API” is set to “necessary” (not “unnecessary”), and a table B21 is defined as a correspondence table thereof, in the data table 212 of FIG. 11. The data table 212 of FIG. 11 differs from the data table 211 of FIG. 3 in these respects. Furthermore, in the data table 212 of FIG. 11, the “necessity of a response information change process” for each of a “registered user information acquisition API” and a “box document information acquisition API” is set to “unnecessary” (not “necessary”). The data table 212 of FIG. 11 also differs from the data table 211 of FIG. 3 in this respect.

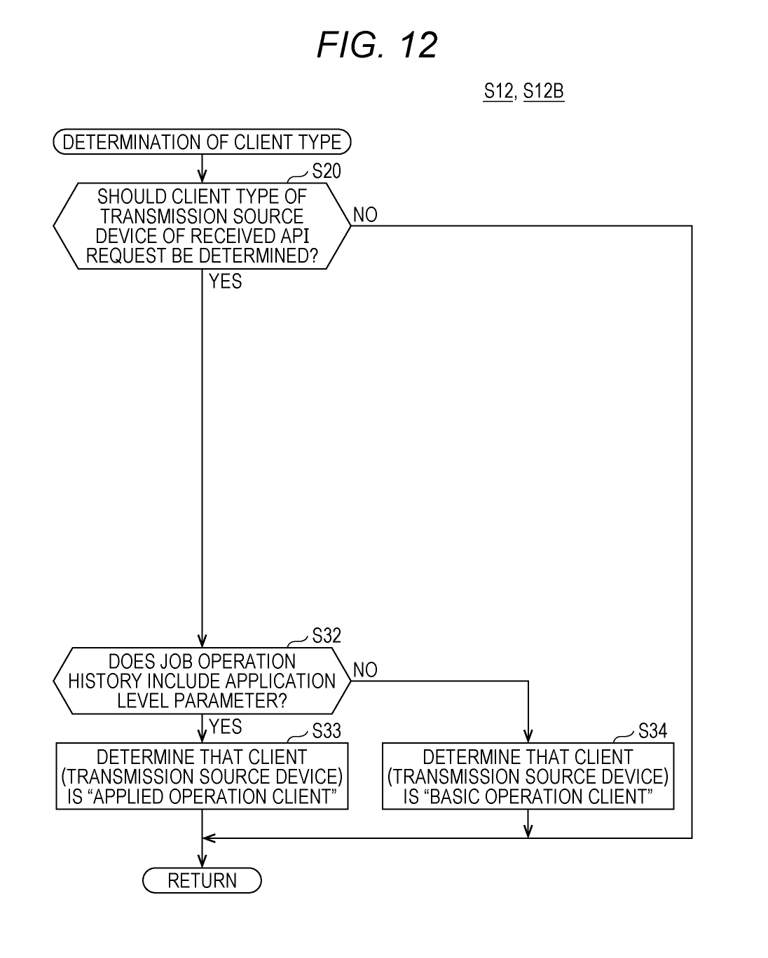

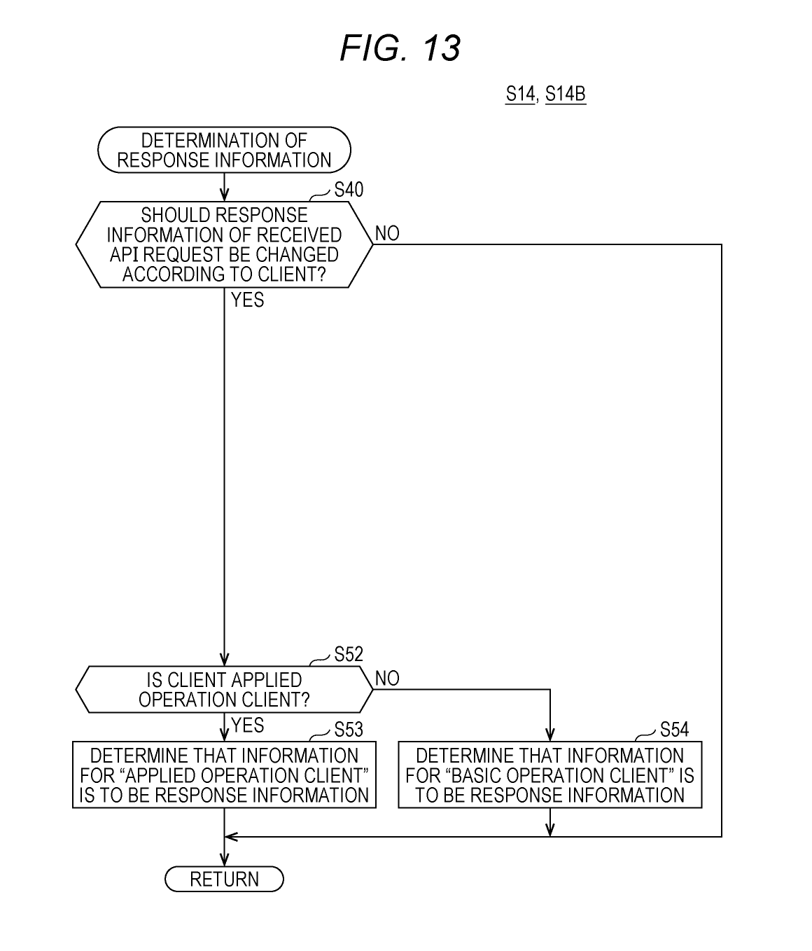

Moreover, in the second embodiment, each operation shown in FIG. 12 is performed as operation of step S12 (instead of each operation shown in FIG. 5). In addition, each operation shown in FIG. 13 is performed as operation of step S14 (instead of each operation shown in FIG. 6).

Specifically, in step S12 (also referred to as S12B) according to the second embodiment, steps S32 to S34 are performed (instead of steps S22 to S24) after step S20 is performed, as shown in FIG. 12.

It should be noted that in the second embodiment, whether to determine a client type is determined in step S20, based on the data table 212 of FIG. 11. In the case where an API received in step S11 is one of a “job execution API”, a “job execution history acquisition API”, the “registered user information acquisition API”, the “box document information acquisition API”, and the like, the “necessity of a response information change process” is defined as “unnecessary” (see FIG. 11). Thus, it is determined that it is not necessary to determine a client type of the transmission source device of the API. Meanwhile, in the case where the API received in step S11 is the “job setting change API” or the like, the “necessity of a response information change process” is defined as “necessary” (see FIG. 11). Thus, it is determined that a client type of the transmission source device of the API should be determined.

For example, in the case where the “job setting change API” has been received in step S11 (FIG. 4), the process proceeds from step S20 to step S32.

In steps S32 to S34, it is determined whether a client type of the transmission source device is the “basic operation client” or “applied operation client”. Here, the “basic operation client” refers to a client that changes settings of only parameters (setting values) of the “basic level” among a plurality of parameters relating to a job (a client that does not change settings of parameters of the “application level” (to be described below)). Meanwhile, the “applied operation client” refers to a client that also changes settings of parameters of the “application level” (parameters other than the parameters of the basic level among the plurality of parameters) among the plurality of parameters relating to a job.

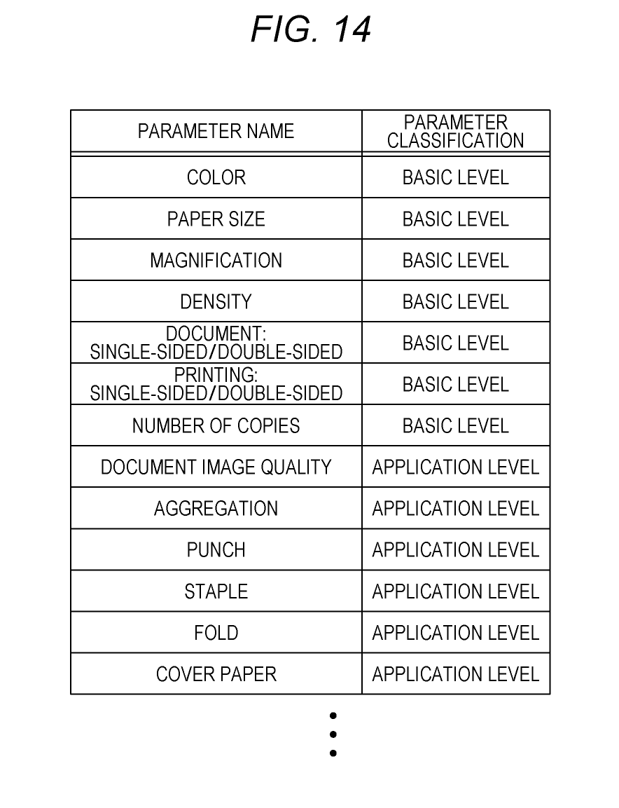

Here, examples of parameters for a copy job include various parameters as shown in FIG. 14. Among the plurality of parameters, parameters concerning the respective items “color”, “paper size”, “magnification”, “density”, “document: single-sided/double-sided”, “printing: single-sided/double-sided”, and “number of copies” are used in basic operation, and are classified as the parameters of the “basic level” (basic level parameters). Meanwhile, parameters concerning the respective items “document image quality”, “aggregation”, “punch”, “staple”, “fold”, “cover paper”, and the like are used not in the basic operation but in applied operation, and are classified as the parameters of the “application level” (application level parameters). It should be noted that parameters for other types of jobs (scan job and the like) are also classified into the “basic level parameters” and “application level parameters” in a similar manner.

In the second embodiment, a client type is determined based on the presence or absence of a setting change record regarding the application level parameter.

Specifically, in step S32, it is determined whether the “application level parameter” has been specified (subjected to a setting change) in the past in a record of a “job setting operation API” having been used by the transmission source device. In other words, it is determined whether an API usage history information 310 includes a record of the “parameter of the application level” having been specified. Then, based on the determination result, it is determined whether the transmission source device is the “applied operation client” or “basic operation client”.

Specifically, when the API usage history information 310 includes the record of the “application level parameter” having been specified by the transmission source device, it is determined that the transmission source device is the “applied operation client” (step S33). Meanwhile, when the API usage history information 310 includes no record of the “application level parameter” having been specified by the transmission source device, it is determined that the transmission source device is the “basic operation client” (step S34).

For example, assume that the transmission source device has an IP address “192.168.56.XXX”. Then, as shown in FIG. 7 (particularly, refer to the fourth row from the top), the API usage history information 310 includes a record of the “job setting change API” having been used by a client with the IP address, and a record of the parameter “aggregation: 2 in 1” having been designated as a parameter for the API by the client. In this case, it is determined that the “job setting change API” accompanied by designation of the application level parameter has been received from (used by) the transmission source device in the past. Then, it is determined that the transmission source device is the “applied operation client” (step S33).

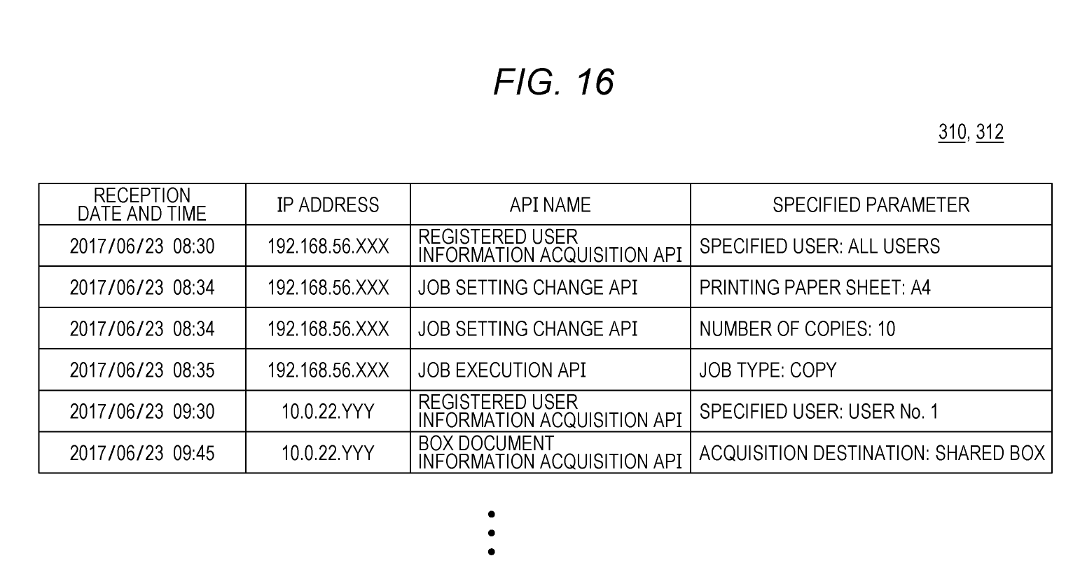

Meanwhile, when API usage history information 310 (312) as shown in FIG. 16 is obtained instead of the API usage history information 310 (311) as shown in FIG. 7, different determination results are obtained. Specifically, the API usage history information 312 (FIG. 16) includes no usage record of an API for which the “application level parameter” such as the “aggregation: 2 in 1” has been specified. Thus, it is determined that the transmission source device is the “basic operation client” (step S34).

It should be noted that in the case where the API usage history information 310 (311) as shown in FIG. 7 is obtained and where it is assumed that the transmission source device has an IP address “10.0.22.YYY”, the API usage history information 310 includes no usage record of an API for which the “application level parameter” has been specified. Thus, it is determined that the transmission source device is the “basic operation client” in a similar manner (step S34).

As described above, the “client type determination process” in the second embodiment is performed based on the second criterion D2 as to whether a parameter of the application level has been specified in the past, in a record of execution of an API relating to job setting operation (job setting change API, and the like). In other words, a client type of the transmission source device is determined based on parameter information (“specified parameter” in the API usage history information 310) on a parameter specified for an API used by the transmission source device in the past.

Next, the operation of step S14 (specifically, S14B (FIG. 13)) is performed. In step S14 (514B), “response information” for the API request received in step S11 is determined based on the client type determined in step S12.

However, in step S14B according to the second embodiment, steps S52 to S54 are performed (instead of steps S42 to S44 shown in FIG. 6) after step S40. Here, assume that the “job setting change API” has been received in step S11. In this case, it is determined that response information for the API should be changed according to the client type. Then, the process proceeds to step S52.

In step S52, it is determined whether the transmission source device of the API is the “applied operation client” or “basic operation client”. Then, according to the determination result, the response information of the API is determined.

Specifically, when the transmission source device of the API is the “applied operation client”, it is determined that information for the “applied operation client” is to be response information (step S53). Meanwhile, when the transmission source device of the API is the “basic operation client”, it is determined that information for the “basic operation client” is to be response information (step S54).

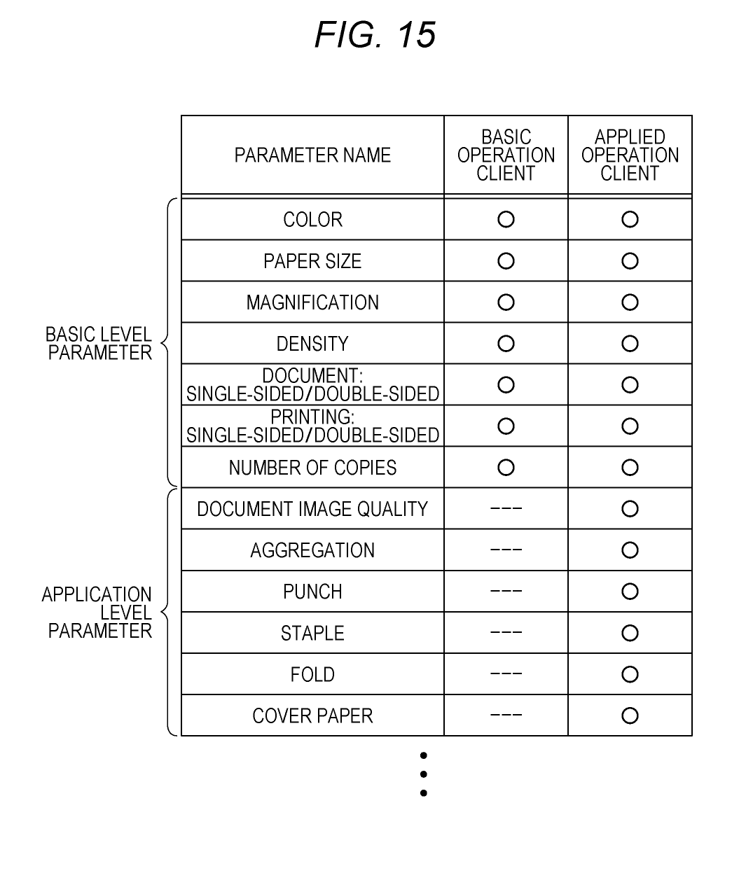

Here, the information for the “applied operation client” and the information for the “basic operation client” are specified in advance for each API. For example, with regard to the “job setting change API”, such information is specified in the data table B21 (FIG. 15).

In the case where the “job setting change API” has been received in step S11, it is determined, based on the data table 210 (212) of FIG. 11, that the data table (response information determination table) B21 corresponding to the “job setting change API” should be further referred to. Then, by referring to the data table B21 (FIG. 15), an MFP 10 acquires the information for the “applied operation client” and the information for the “basic operation client” (steps S53 and S54).

A group of candidates for response information for the “job setting change API” are listed in the data table B21 of FIG. 15 Specifically, a group of parameters such as “color”, “paper size”, “magnification”, “density”, “document: single-sided/double-sided”, “printing: single-sided/double-sided”, “number of copies”, “document image quality”, “aggregation”, “punch”, “staple”, “fold”, and “cover paper” is defined as the group of candidates for response information. It should be noted that the data table B21 is stored in advance in the MFP 10.

Additionally, in the data table B21, only the parameter group of the basic level (“color”, “paper size”, “magnification”, “density”, “document: single-sided/double-sided”, “printing: single-sided/double-sided”, “number of copies”, and the like) is defined as the information for the “basic operation client”, out of the group of candidates for response information for the API (“job setting change API”).

Furthermore, in the data table B21, not only the parameter group of the basic level but also the parameter group of the application level (“document image quality”, “aggregation”, “punch”, “staple”, “fold”, “cover paper”, and the like) are defined as the information for the “applied operation client”, out of the group of candidates for response information for the API (“job setting change API”). In short, all of the group of candidates for response information is defined as the information for the “applied operation client”.

In step S53, it is determined that the information (both of the basic level parameter group and the application level parameter group) for the “applied operation client” is to be response information, based on the data table B21. In addition, in step S54, it is determined that the information (the basic level parameter group only) for the “basic operation client” is to be response information, based on the data table B21.

It should be noted that in the case where the “job setting change API” common to a plurality of job types is received in step S11, response information may be determined as follows: in step S54, it is determined that only the basic level parameter group is to be response information, out of a group of parameters for the plurality of job types (the group of candidates for response information); and in step S53, it is determined that both of the basic level parameter group and the application level parameter group are to be response information, out of the group of parameters for the plurality of job types. Alternatively, in the case where an API (for example, a “copy job setting change API”) unique to each of a plurality of job types is received in step S11, response information may be determined as follows: in step S54, it is determined that only the basic level parameter group is to be response information, out of a group of parameters (the group of candidates for response information) for a specific job type (for example, the “copy job”) corresponding to the API; and in step S53, it is determined that both of the basic level parameter group and the application level parameter group are to be response information, out of the group of parameters for the specific job type.

Subsequently, the processes of steps S16 and S17 are performed.

According to the operation as described above, for the applied operation client that also performs the applied operation, the MFP 10 can appropriately transmit, to the client, information having at least a certain degree of possibility of being used by the client, by returning all the information of the group of candidates (both the basic level parameter group and the application level parameter group) as response information.

Meanwhile, for the basic operation client that performs only the basic operation, it is possible to reduce the amount of data to be transmitted, by returning a relatively small amount of data (only the basic level parameter group) as response information. Therefore, it is possible to prevent an increase in time required for, for example, a receiving process and a process of analyzing received data, at the client.

In this way, the MFP 10 can efficiently transmit information to a client (transmission source device) as the request source of an API.

### 3. Third Embodiment

A third embodiment is a variation relating to a combination of the first embodiment and the second embodiment. The third embodiment will be described below with a focus on differences from the first embodiment described above and others.

In the third embodiment, a client type of a transmission source device is determined based on criteria (specifically, two criteria D1 and D2) different for each API. Furthermore, for each API, response information is determined according to a client type based on a different classification method.

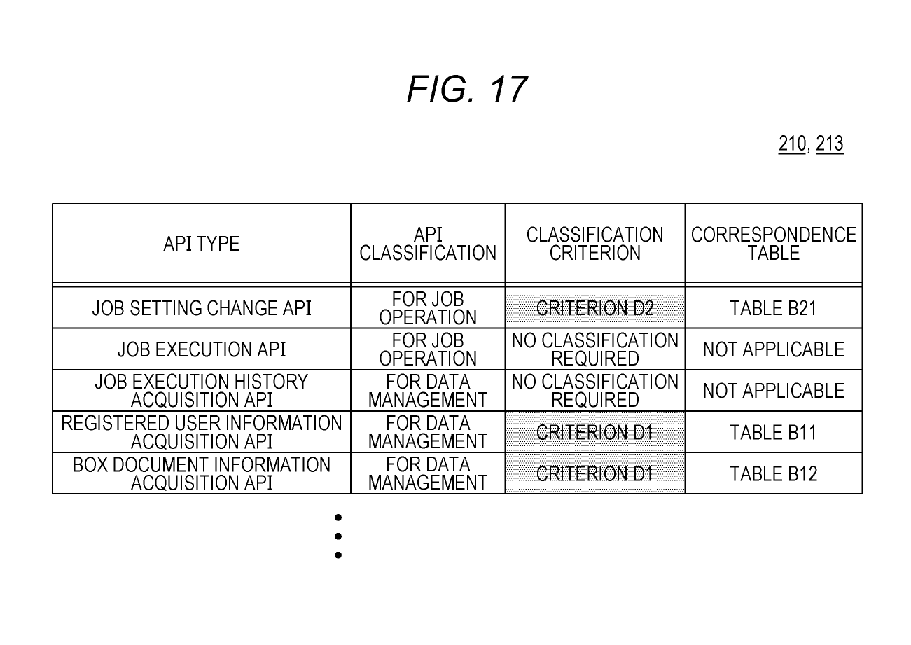

In the third embodiment, a data table 210 (213) shown in FIG. 17 is used in place of the data tables 211 and 212 (see FIGS. 3 and 11).

The data table 213 of FIG. 17 includes the column “classification criterion” instead of “necessity of a response information change process”. The “classification criterion” defines the criteria (D1 and D2) and the like for determining a client type at the time of determination of response information for each API. For example, it is specified that the above-described second criterion D2 should be used in a process for determining a client type of a transmission source device of a “job setting change API”. In addition, it is specified that the above-described first criterion D1 should be used in a process for determining a client type of a transmission source device of each of a “registered user information acquisition API” and a “box document information acquisition API”. Furthermore, the column “classification criterion” includes the description “no classification required” defined for the case where no response information change process is required (the case where no criterion for client types is required).

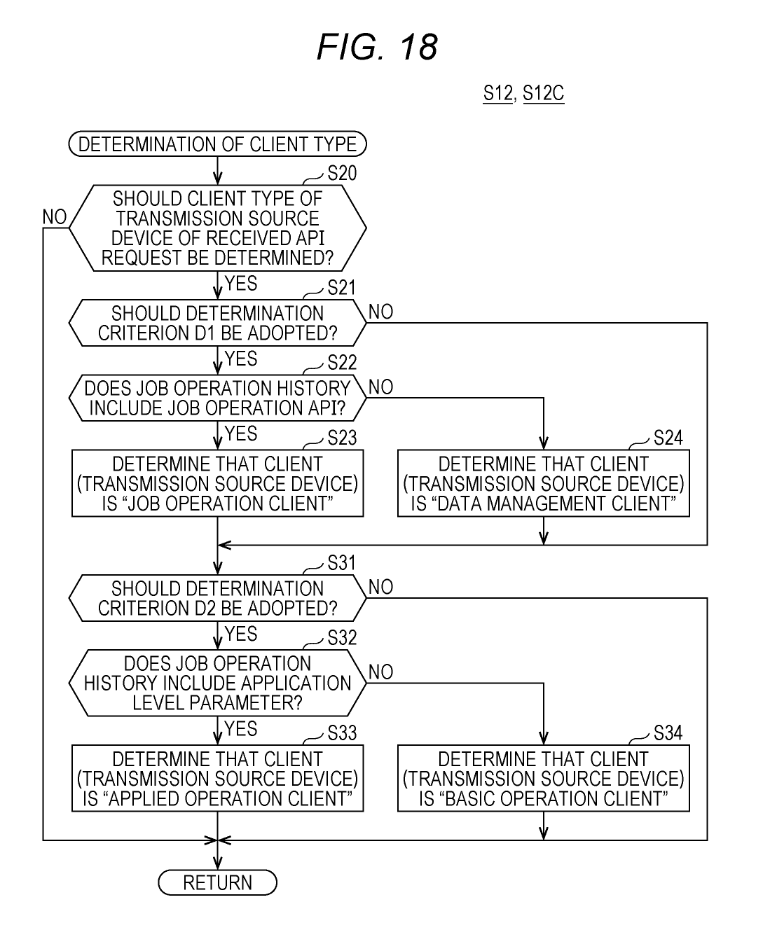

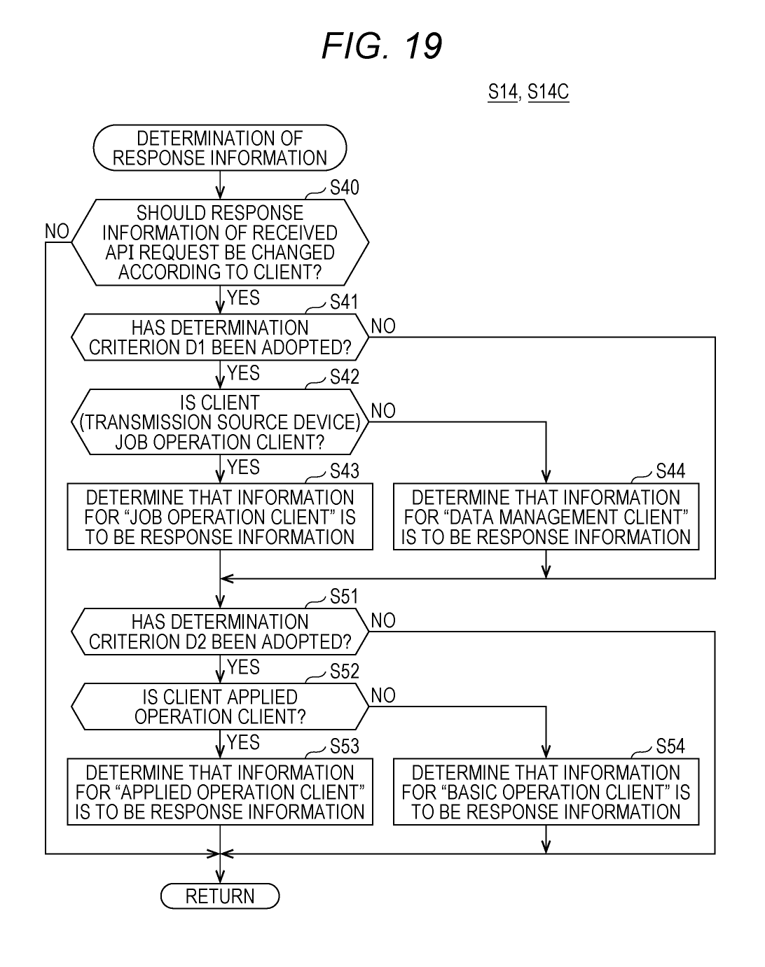

Moreover, in the third embodiment, each operation shown in FIG. 18 is performed as operation of step S12. In addition, each operation shown in FIG. 19 is performed as operation of step S14.

Specifically, in step S12 (also referred to as S12C) according to the third embodiment, steps S21 to S24 and S31 to S34 are performed after step S20 is performed, as shown in FIG. 18.

In steps S21 and S31, it is determined which of the determination criteria D1 and D2 should be adopted as a criterion for determining a client type of a transmission source device of an API request received in step S11.

When it is determined, with reference to the data table 213 (FIG. 17), that the determination criterion D1 should be adopted, an MFP 10 proceeds to step S22 (from step S20 via step S21). Then, in step S23 or step S24, a client type (job operation client/data management client) is determined based on the determination criterion D1. When it is determined that the determination criterion D1 should be adopted, the processes of steps S32 to S34 are not performed.

Meanwhile, when it is determined, with reference to the data table 213 (FIG. 17), that the determination criterion D2 should be adopted, the MFP 10 proceeds to step S32 (from step S20 via steps S21 and S31). Then, in step S33 or step S34, a client type (applied operation client/basic operation client) is determined based on the determination criterion D2. When it is determined that the determination criterion D2 should be adopted, the processes of steps S22 to S24 are not performed.

Subsequently, the process of step S14 (514C) (FIG. 19) is performed.

As shown in FIG. 19, in step S14 (also referred to as S14C) according to the third embodiment, steps S41 to S44 and S51 to S54 are performed after step S40 is performed.

In steps S41 and S51, it is determined which of the determination criteria D1 and D2 has been adopted in step S12C as a criterion for determining a client type of the transmission source device of the API request received in step S11.

In the case where the determination criterion D1 has been adopted, the process proceeds to step S42 (from step S40 via step S41). Then, in step S43 or step S44, response information is determined according to the client type (job operation client/data management client) determined in step S12C. In the case where the determination criterion D1 has been adopted, the processes of steps S52 to S54 are not performed.

Meanwhile, in the case where the determination criterion D2 has been adopted, the process proceeds to step S52 (from step S40 via steps S41 and S51). Then, in step S53 or step S54, response information is determined according to the client type (applied operation client/basic operation client) determined in step S12C. In the case where the determination criterion D2 has been adopted, the processes of steps S42 to S44 are not performed.

According to the aspect as described above, effects similar to those of the first embodiment and the second embodiment can be obtained. In addition, it is possible to more appropriately determine a client type for each API, and also possible to more appropriately determine response information for each API. Therefore, for more diverse APIs, the MFP 10 can efficiently transmit information to a client (transmission source device) as the request source of each API.

### 4. Variation and Others

The embodiments of the present invention have been described above. However, the present invention is not limited to the above-described matters.

For example, in each of the above-described embodiments, the same processes (steps S12 to S17) are performed on a consistent basis when a request for one API is accepted from one transmission source device in step S11 (FIG. 4). However, the present invention is not limited thereto. Specifically, when a request for one API is accepted from one transmission source device in step S11, operation different from the above may be performed in the case where the request is a re-request transmitted within a predetermined period of time.

Specifically, the following case is assumed here. In step S11, a request for one API is accepted from one transmission source device, and response information determined in step S14 is transmitted to the one transmission source device in step S16. Then, a re-request, which is a request for the same API as the one API, is accepted from the transmission source device (the same device as the transmission source device of the one API) within a predetermined period of time (for example, within one minute) after acceptance of the request for the one API (or transmission performed in step S16). In this case, it is possible to adopt a configuration in which the processes of steps S12 and S14 are not performed. Then (this time), in step S16, an MFP 10 may determine that all of a group of candidates for response information for the API are to be response information for the re-request, and transmit, to the transmission source device, all of the group of candidates as the response information for the re-request. It should be noted that the present variation is based on the assumption that a client 70 is configured to transmit a re-request when necessary information is not included in response information returned in response to one API request.

In the variation as described above, all data of the group of candidates for response information (a wider range of data than in the case of a part of data) are transmitted as response information for a “re-request” even in the case where only a part of all the data of the group of candidates for response information (for example, “response information for a data management client” or “response information for a basic operation client”) has been transmitted as response information for one request (first request).

As a result, even if the result of a client type determination process (estimation process) in step S12 for the first request is not appropriate and necessary information cannot be obtained as response information for the first request accordingly, the client 70 can obtain necessary information by transmitting a re-request to the MFP 10 within a predetermined period of time.

Furthermore, in each of the embodiments described above, a client type of a transmission source device is determined (estimated) based on the API usage history information 310. However, the present invention is not limited thereto.

For example, a client type of a transmission source device may be determined based on an IP address of the transmission source device received from the transmission source device.

Specifically, a client type (“data management client”/“job operation client”) may be determined according to whether the IP address of the transmission source device is a global IP address or a private IP address.

More specifically, in the case where a transmission source device has an IP address “192.168.56.XXX” or the like, it is determined that the IP address is a private IP address. In this case, it is highly possible that the transmission source device (client 70) exists within a company. Therefore, the MFP 10 determines that job execution in the MFP 10 is about to be operated by use of the client 70, and determines that the transmission source device is the “job operation client” accordingly.

Meanwhile, in the case where a transmission source device has an IP address “10.0.22.YYY” or the like, it is determined that the IP address is a global IP address. In this case, it is highly possible that the transmission source device (client 70) exists outside a company. Therefore, the MFP 10 determines that job execution in the MFP 10 is less likely to be operated by use of the client 70, and determines that the transmission source device is the data management client (not the job operation client) accordingly.

In this manner, a client type of a transmission source device may be determined (estimated) based on an IP address of the transmission source device (specifically, according to whether the IP address of the transmission source device is a global IP address or private IP address).

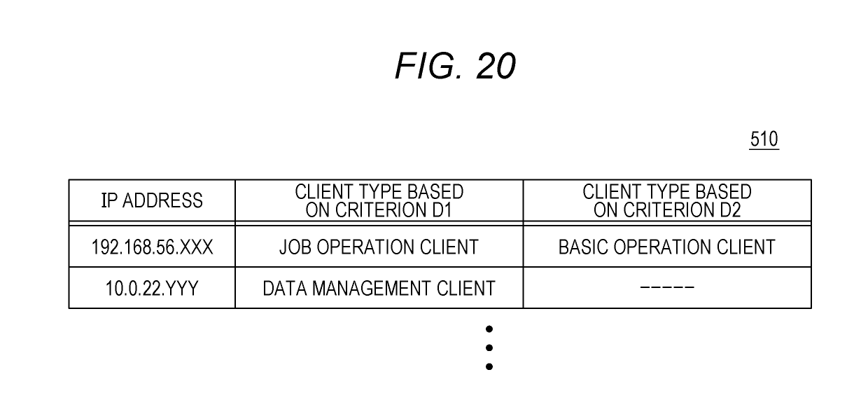

Alternatively, a client type of a transmission source device may be determined based on device identification information (IP address and the like) of the transmission source device, received from the transmission source device, and a data table 510 (see FIG. 20) that defines a correspondence relationship between the device identification information of each client and client type information of each client. In other words, a client type may be determined based on a fixed correspondence relationship between an IP address and a client type.

Specifically, the MFP 10 stores the data table 510 (FIG. 20) that defines a correspondence relationship between the device identification information (IP address and the like) of each client and the client type information of each client. Then, a client type of a transmission source device may be determined based on the data table 510 and device identification information (IP address) of the transmission source device received from the transmission source device. For example, when the determination criterion D1 is adopted in the case where a transmission source device has the IP address “192.168.56.XXX”, it may be determined that the transmission source device is the “job operation client” based on the data table 510. Similarly, when the determination criterion D2 is adopted in the case where a transmission source device has the IP address “192.168.56.XXX”, it may be determined that the transmission source device is the “basic operation client”.

Furthermore, the method of determining a client type in the present modified example and the method of determining a client type in each of the above-described embodiments may be combined depending on the situation. Specifically, when an API usage history information 310 includes a usage history of a transmission source device, a client type of the transmission source device is determined based on the API usage history information 310 as in each of the above-described embodiments. Meanwhile, when the API usage history information 310 includes no usage history of the transmission source device, a client type of the transmission source device may be determined based on an IP address of the transmission source device received from the transmission source device (and the data table 510) as in the above-described modified example.

Incidentally, it is possible to easily determine a client type by determining a client type of a transmission source device of an API request based on history information (API usage history information 310) of an API request from each client, as in each of the above-described embodiments. In addition, response information for a request for an API is determined according to a client type determined based on the API usage history information 310. Thus, it is possible to flexibly and appropriately determine response information.

Particularly, as compared with the case of determination based on an IP address (and the data table 510) as in the modified example described above, it is possible to flexibly address a change of services to be used by a device with the same IP address (a change of APIs to be used by the device). More specifically, it is possible to automatically change a determination result of a client type according to an automatic change of the history information in the API usage history information 310, without making a change to the data table 510.

For example, it is possible to automatically change a determination result of a client type from the basic operation client to the applied operation client (or from the data management client to the job operation client). More specifically, in the case where a status of a client having been treated as the basic operation client is changed such that the client is treated as the applied operation client, a client type of the client is automatically changed based on the history information in the API usage history information 310, and response information for the client is also automatically changed to “information for the applied operation client”.

As described above, according to each of the above-described embodiments, it is possible to flexibly and appropriately determine response information, as compared with the case where response information is determined based on a client type allocated to an IP address in a fixed manner.

In addition, particularly, it is possible to accurately determine a client type, as compared with the case where a client type is determined according to whether an IP address is a global IP address or private IP address as in another modified example described above.

Furthermore, in each of the above-described embodiments and the like, the API usage history information 310 is stored in the MFP 10. However, the present invention is not limited thereto.

For example, the API usage history information 310 may be stored in an external server (a storage device or the like of the external server) provided separately from the MFP 10.

In such a case, the MFP 10 may transmit, to the external server, a transmission request for API usage history information (specifically, usage history information of a plurality of APIs relating to a transmission source device of an API), and perform determination operation in a manner similar to each of the above-described embodiments and the like, based on the API usage history information received in response to the transmission request.

Furthermore, the determination operation may be performed by the external server. In other words, the determination operation may be performed not by the MFP 10 but by the external server. More specifically, the MFP 10 inquires of the external server a client type of a transmission source device. The external server performs the determination process, and returns a result of the process (an inquiry result from the external server) to the MFP 10. Then, the MFP 10 may acquire a client type of the transmission source device based on the inquiry result. It should be noted that the external server may determine in advance a client type of each device based on the API usage history information 310 (prior to an inquiry from the MFP 10). Alternatively, the external server may determine in advance a client type of each device by a method other than the method using the API usage history information 310.

Additionally, in each of the above-described embodiments, a client type is determined based on the first criterion D1 and/or the second criterion D2. However, determination criteria are not limited thereto, and a client type may be determined based on other criteria. Furthermore, client types may be types other than those described above.

Although embodiments of the present invention have been described and illustrated in detail, the disclosed embodiments are made for purposes of illustration and example only and not limitation. The scope of the present invention should be interpreted by terms of the appended claims

What is claimed is:

1. An image processing apparatus comprising:
a hardware processor that accepts, from a client, a request for an API relating to the image processing apparatus,
determines a client type of the client, which is a transmission source device of the request, based on history information of an API request from each client, and
determines response information for the request for the API, based on the client type of the client; and
a transmitter that transmits the determined response information to the client.

2. The image processing apparatus according to claim 1, wherein
the hardware processor determines whether the client type is a first type of client, which performs job operation in the image processing apparatus, or a second type of client, which does not perform the job operation in the image processing apparatus.

3. The image processing apparatus according to claim 2, wherein
the hardware processor determines whether the client type of the transmission source device is the first type of client or the second type of client based on a first criterion as to whether the history information includes a record of execution of an API relating to the job operation, as a past API request from the client.

4. The image processing apparatus according to claim 2, wherein
the hardware processor:
determines that out of a group of candidates for the response information for the API, only basic information is to be the response information for the API in a case where it is determined that the transmission source device is the second type of client, the basic information being to be used for both data management and the job operation; and
determines that out of the group of candidates for the response information for the API, not only the basic information but also applied information are to be the response information for the API in a case where it is determined that the transmission source device is the first type of client, the applied information being to be used not for the data management but for the job operation.

5. The image processing apparatus according to claim 1, wherein
the hardware processor determines whether the client type is a third type of client or a fourth type of client, the third type of client being a client that also changes a setting of a parameter of an application level which is a parameter other than a parameter of a basic level among parameters relating to a job, the fourth type of client being a client that does not change a setting of a parameter of the application level, but changes a setting of a parameter of the basic level.

6. The image processing apparatus according to claim 5, wherein
the hardware processor determines whether the client type of the transmission source device is the third type of client or the fourth type of client, based on a second criterion as to whether a parameter of the application level has been specified before in a record of execution of an API relating to job setting operation.

7. The image processing apparatus according to claim 5, wherein
the hardware processor:
determines that out of a group of candidates for the response information for the API, only a parameter group of the basic level is to be the response information for the API in a case where it is determined that the transmission source device is the fourth type of client; and
determines that out of the group of candidates for the response information for the API, not only the parameter group of the basic level but also a parameter group of the application level are to be the response information for the API in a case where it is determined that the transmission source device is the third type of client.

8. The image processing apparatus according to claim 1, further comprising:
a storage that stores the history information of an API request from each client.

9. The image processing apparatus according to claim 1, wherein
the hardware processor determines the client type of the transmission source device based on an IP address of the transmission source device, received from the transmission source device, in a case where the history information includes no usage history of the transmission source device.

10. The image processing apparatus according to claim 1, wherein
the hardware processor determines the client type of the transmission source device based on an IP address of the transmission source device, received from the transmission source device.

11. The image processing apparatus according to claim 9, wherein
the hardware processor determines the client type of the transmission source device according to whether the IP address of the transmission source device, received from the transmission source device, is a global IP address or a private IP address.

12. The image processing apparatus according to claim 1, wherein
the transmitter transmits, to the transmission source device, all of a group of candidates for the response information for the API as response information for a re-request, which is a request for a same API as the API, in a case where the re-request is accepted from the transmission source device within a predetermined period of time after the determined response information is transmitted to the client.

13. An image processing system comprising:
an image processing apparatus; and
a server,
wherein the image processing apparatus includes:
a hardware processor that accepts, from a client, a request for an API relating to the image processing apparatus, and
determines response information for the request for the API based on a client type of the client, which is a transmission source device of the request; and
a transmitter that transmits the determined response information to the client,
the image processing apparatus inquires of the server the client type of the transmission source device,
the server determines the client type of the client, which is the transmission source device of the request, based on history information of an API request from each client, and
the image processing apparatus acquires the client type based on an inquiry result from the server.

14. A control method for an image processing apparatus, comprising:
a) accepting, from a client, a request for an API relating to the image processing apparatus;
b) determining a client type of the client, which is a transmission source device of the request, based on history information of an API request from each client;
c) determining response information for the request for the API, based on the client type of the client; and
d) transmitting the determined response information to the client.

15. The control method according to claim 14, further comprising:
e) transmitting, to the transmission source device, all of a group of candidates for the response information for the API as response information for a re-request, which is a request for a same API as the API, in a case where the re-request is accepted from the transmission source device within a predetermined period of time after the response information, determined in the c), is transmitted to the client in the d).

16. A non-transitory recording medium storing a computer readable program causing a computer incorporated in the image processing apparatus to perform the control method according to claim 14.
